(19) United States
(12) Patent Application Publication
(10) Pub. No.: US 2024/0242132 A1
(43) Pub. Date: Jul. 18, 2024

(54) PARKING RESERVATION MANAGEMENT DEVICE

(71) Applicant: TOYOTA JIDOSHA KABUSHIKI KAISHA, Aichi-ken (JP)

(72) Inventors: Takuji MATSUBARA, Aichi-ken (JP); Osamu YUMITA, Aichi-ken (JP); Naoki HASEGAWA, Aichi-ken (JP); Sa KANO, Aichi-ken (JP)

(21) Appl. No.: 18/395,744

(22) Filed: Dec. 26, 2023

(30) Foreign Application Priority Data
Jan. 12, 2023 (JP) 2023-002831

(51) Int. Cl. G06Q 10/02

(52) U.S. Cl. CPC G06Q 10/02

(57) ABSTRACT

The parking reservation management device manages parking reservation for the parking lot with chargeable and dischargeable parking space where the charging and discharging device that charges and discharges the battery installed in the vehicle is installed. The parking reservation management device sends a changing availability guide to the user to inform whether a user side information can be changed or not, when the deviation between a desired facility-side power adjustment period based on the power demand at predetermined facility and a vehicle-side power adjustment availability period obtained based on the user side information on the use of the parking lot input by the user is outside a predetermined range.

### CROSS-REFERENCE TO RELATED APPLICATION

The present disclosure claims priority to Japanese Patent Application No. 2023-002831 filed on Jan. 12, 2023, which is incorporated herein by reference in its entirety including specification, drawings and claims.

### TECHNICAL FIELD

The present disclosure relates to a parking reservation management device, and in particular, to a parking reservation management device for a parking lot having a chargeable and dischargeable parking space to which a charging and discharging device for charging and discharging a battery installed in a vehicle is attached.

### BACKGROUND

Conventionally, a system with a storage battery installed in a parking lot, an AC power converter for this storage battery, and a charging and discharging stand for electric vehicles has been proposed that can also supply power to a load from the charging and discharging stand or the AC power converter(for example, refer to Patent Document 1). In this system, power is supplied to the load from a charging and discharging stand or an AC power converter, so that power can be supplied to the load even in the event of a failure of the commercial power system.

### Citation List

### Patent Literature

PTL 1: JP2020-010442

### SUMMARY

The parking lot with chargeable and dischargeable parking spaces equipped with charging and discharging device that can charge and discharge the vehicle-mounted batteries must coordinate with the electricity demand at the facility that exchanges electricity with the parking lot. In other words, it is necessary to adjust the parking timing of vehicles parked in chargeable and dischargeable parking spaces according to the timing of electricity supply and demand between the parking lot and the facility exchanging electricity.

The main purpose of the parking reservation management device of the present disclosure is to provide more appropriate parking timing for vehicles parked in chargeable and dischargeable parking spaces in the parking lot.

The parking reservation management device of the present disclosure has adopted the following means to achieve the main objectives described above.

The parking reservation management device of this disclosure is a parking reservation management device for a parking lot that can communicate via a communication network, having a chargeable and dischargeable parking space to which a charging and discharging device for charging and discharging a battery mounted on a vehicle is attached to at least a portion of all parking spaces, and capable of exchanging electric power between the parking lot and a predetermined facility, the parking reservation management device is characterized by: sending a changing availability guide to a user to inform whether a user side information can be changed or not, when a deviation between a desired facility-side power adjustment period based on a power demand at the predetermined facility and a vehicle-side power adjustment availability period obtained based on the user side information on the use of the parking lot input by the user is outside a predetermined range.

The parking reservation management device of the present disclosure manages reservations for the parking lot that has the chargeable and dischargeable parking space where the charging and discharging devices that charge and discharge the batteries installed in the vehicle are installed, and can exchange power with the predetermined facility. The parking reservation management device, when reserving a parking space, sends a changing availability guide to the user to inform whether a user side information can be changed or not, when the deviation between a desired facility-side power adjustment period based on the power demand at predetermined facility and a vehicle-side power adjustment availability period obtained based on the user side information on the use of the parking lot input by the user is outside a predetermined range. This allows the user to be encouraged to change in a direction where the deviation between the desired facility-side power adjustment period and the vehicle-side power adjustment availability period is within the predetermined range. This results in more appropriate parking timing for vehicles parked in the chargeable and dischargeable parking spaces in the parking lot.

### BRIEF DESCRIPTION OF DRAWINGS

FIG. 1 shows a schematic configuration of the parking reservation system 10 including the parking reservation management device 20 as an embodiment of the present disclosure.

FIG. 2 shows a schematic configuration of the electric vehicle 120 that can use the chargeable and dischargeable parking space 36 of the parking lot 30.

FIG. 3 shows a flowchart of an example of the parking reservation process executed by the parking reservation management unit 24 and the parking application 230.

FIG. 4 shows a schematic configuration of a modified parking reservation system 10B.

### DESCRIPTION OF EMBODIMENTS

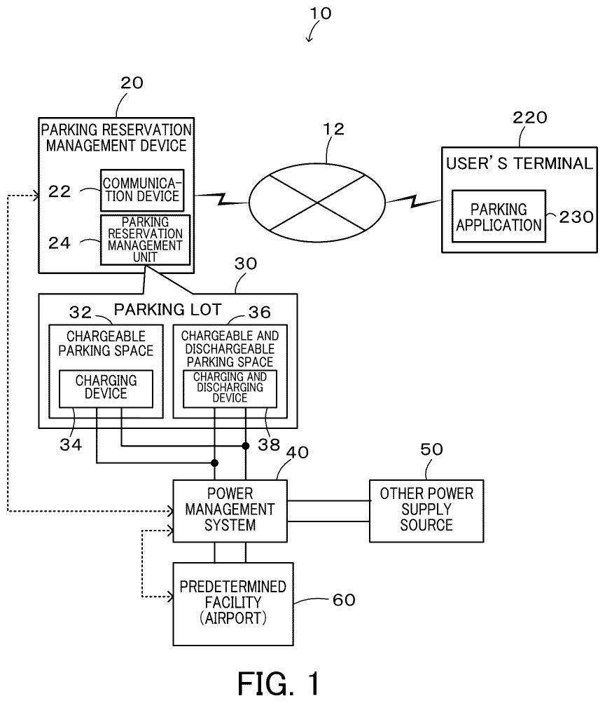

Next, the embodiment of this disclosure will be described. FIG. 1 shows a schematic configuration of the parking reservation system 10 including the parking reservation management device 20 as an embodiment of the present disclosure. The parking reservation system 10 has the communication network (wired or wireless) 12, the parking reservation management device 20 connected to the communication network 12, and the users' terminal 220 connected to the communication network 12.

The parking reservation management device 20 accepts parking reservations for parking spaces in the parking lot 30 attached to the predetermined facility (e.g., airport) 60. The parking reservation management device 20 is composed of a microcomputer, for example. The parking reservation management device 20 has a communication device 22 for communicating with the communication network 12 and the parking reservation management unit 24 that accepts and manages parking reservations. The parking reservation management unit 24 is a functional block that functions as a combination of hardware and application software.

The parking lot 30 has a plurality of the chargeable parking space 32 with the charging device 34 that can only charge the battery installed in the vehicle, a plurality of the chargeable and dischargeable parking space 36 with the charging and discharging device 38 that can charge and discharge the battery installed in the vehicle, and a plurality of the general parking spaces (not shown) where the charging device 34 or charging and discharging device 38 is not installed. Each parking space is assigned parking space information including identification number, type, and location. The parking space information is stored in the parking reservation management unit 24 of the parking reservation management device 20.

Each of the charging device 34 installed in a plurality of the chargeable parking space 32 is connected by a power line to the other power supply source 50 via the power management system 40. Each charging device 34 charges the battery on the vehicle parked in the chargeable parking space 32 using power from the other power supply source 50. Each of the charging and discharging device 38 installed in a plurality of the chargeable and dischargeable parking space 36 is connected by power lines to the other power supply source 50 or to the predetermined facility 60 via the power management system 40. Each of the charging and discharging device 38 charges the battery on the vehicle parked in chargeable and dischargeable parking space 36 using power supplied from the other power supply source 50, or supplies power from the battery to the predetermined facility 60.

The power management system 40 manages the charging of batteries mounted on parked vehicles by supplying power from the other power supply source 50 to the charging device 34 in the chargeable parking space 32 and the charging and discharging device 38 in the chargeable and dischargeable parking space 36. The power management system 40 manages the supply of power from the other power supply source 50 to the predetermined facility 60. The power management system 40 manages the supply of power from the charging and discharging device 38 in the chargeable and dischargeable parking space 36 to the predetermined facility 60.

The other power supply source 50 are envisioned to include, for example, at least some of the following: the commercial power supply, the solar power supply, the wind power supply, the tidal power supply, and the geothermal power supply.

The users' terminal 220 is configured, for example, as a portable communication terminal. The users' terminal 220 has the parking application 230 installed, which can be used with the parking reservation system 10.

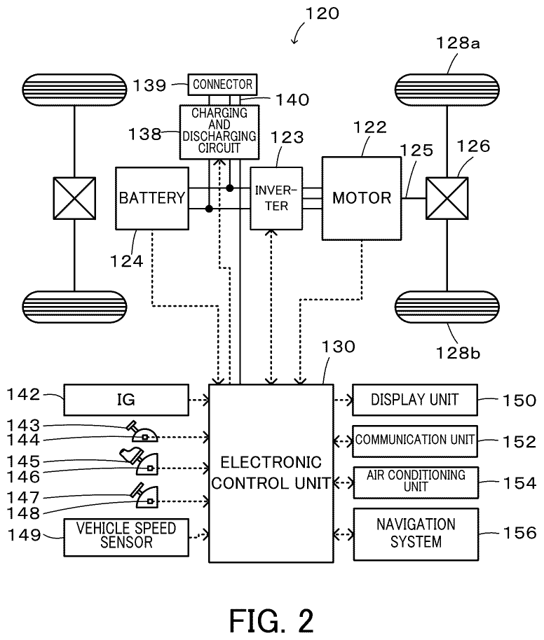

The vehicle that can use the chargeable and dischargeable parking space 36 in the parking lot 30 can be, for example, the electric vehicle 120 illustrated in FIG. 2. The electric vehicle 120 is equipped with the motor 122, the inverter 123, the battery 124, the charging and discharging circuit 138, the connector 139, and the electronic control unit 130.

The motor 122 is configured, for example, as the synchronous generator motor. The rotor of the motor 122 is connected to the drive shaft 125 connected to the drive wheels 128a, 128b via the differential gear 126. The motor 122 is driven by three-phase AC power applied by the inverter 123 after DC power from the battery 124 is converted to three-phase AC power by the inverter 123. The battery 124 is configured as a well-known lithium-ion rechargeable battery or nickel-metal hydride rechargeable battery.

The charging and discharging circuit 138 is connected at one end to a power line connected to the battery 124 and at the other end to the connector 139 for connection to the charging and discharging device 38. The charging and discharging circuit 138 has the charging and discharging relay, which is not shown in the figure. The charging and discharging circuit 138 is connected to and disconnected from the battery 124 by the charging and discharging relay.

The electronic control unit 130 is configured as a microcomputer, which is mainly composed of a CPU, not shown in the figure. The electronic control unit 130 receives signals from various sensors via input ports. For example, the electronic control unit 130 inputs the ignition signal from the ignition switch 142, the shift position SP from the shift position sensor 144 that detects the position of the shift lever 143, the acceleration Acc from the accelerator pedal position sensor 146 that detects the amount of depressing the accelerator pedal 145, the brake position BP from the brake pedal position sensor 148 that detects the amount of depressing the brake pedal 147, and the vehicle speed V from the vehicle speed sensor 149. The electronic control unit 130 also inputs the rotation position θ from the rotation position sensor (not shown) that detects the rotation position of the motor 122, the battery voltage Vb from the voltage sensor (not shown) attached to the output terminal of the battery 124, the battery current Ib from the current sensor (not shown) attached to the output terminal of the battery 124, the charging and discharging voltage Vchg from the voltage sensor attached to the charging and discharging circuit 138, and the charging and discharging current Ichg from the current sensor attached to the charging and discharging circuit 138.

The electronic control unit 130 outputs various control signals via output ports. For example, the electronic control unit 130 outputs the display control signals to the display unit 150, the communication control signals to the communication unit 152, and the air conditioning control signals to the air conditioning unit 154. The electronic control unit 130 also outputs the switching control signals for switching the switching elements (not shown) to the inverter 123 to drive the motor 122, the drive control signals to the system main relay (not shown) mounted near the battery 124, and the drive control signal to the charging and discharging relay (not shown) attached to the charging and discharging circuit 138. The electronic control unit 130 communicates with the navigation system 156, which displays various information and provides route guidance. The signal line 140 is connected to the electronic control unit 130 to communicate with the charging and discharging device 38 when the charging and discharging device 38 is connected via the connector 139.

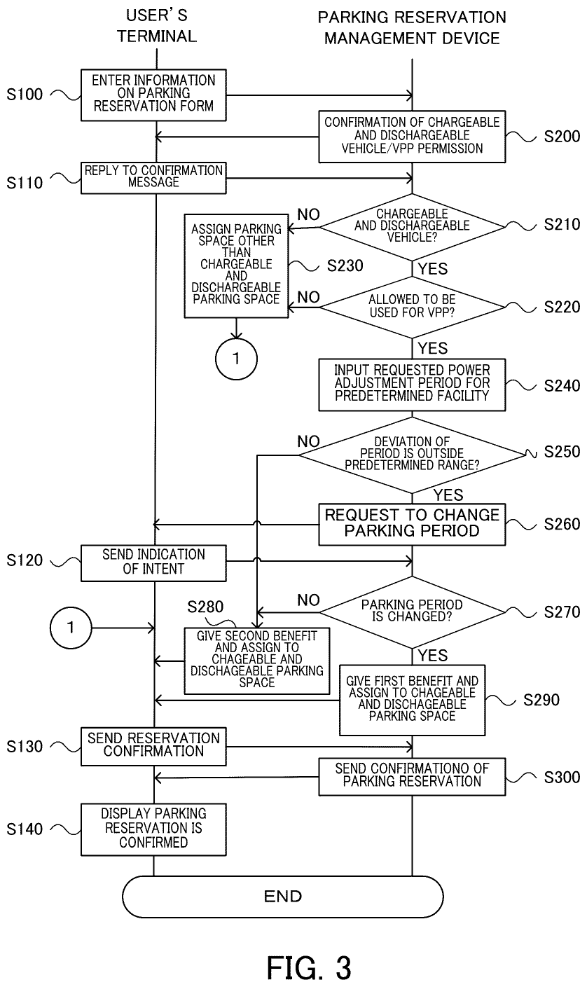

Next, the operation of the parking reservation system 10 of the embodiment, especially the operation when making a parking reservation, will be described. FIG. 3 shows a flowchart of an example of the parking reservation process executed by the parking reservation management unit 24 and the parking application 230.

The parking reservation process begins by entering the required information on the parking reservation form from the users' terminal 220 and transmitting it to the parking reservation management device 20 (step S100). The parking reservation form is activated by using the parking application 230 installed on the users' terminal 220. Items to be entered in the parking reservation form include, for example, the user's name, user's address, the scheduled entry date and time to the parking lot, the scheduled exit date and time from the parking lot, the type of the vehicle, whether or not the vehicle's onboard battery can be charged and discharged, whether or not the onboard battery needs to be charged before the vehicle leaves, whether or not the vehicle's onboard battery can be used as a VPP (Virtual Power Plant) during parking, etc.

The parking reservation management device 20 confirms the vehicle is a chargeable and dischargeable vehicle that can be used for VPP for those users whose parking reservation form entry from the users' terminal 220 permits them to use the vehicle for VPP and the parking reservation for the vehicle that allows charging and discharging of the on-board battery. The parking reservation management device 20 also sends a control signal to the users' terminal 220 to display a confirmation of permission to use the VPP (step S200). The confirmation should read, for example, “This vehicle is available for use in a Virtual Power Plant (VPP). Please confirm permission for use in a VPP.” or something like that. In response to the confirmation message, the user replies with a “yes” or “no” response from the users' terminal 220 (step S110).

The parking reservation management device 20 determines whether the confirmation reply from the users' terminal 220 confirms that the vehicle is a chargeable and dischargeable vehicle that can be used for the VPP (step S210). The parking reservation management device 20 also determines whether or not it has confirmed that the battery of the parked vehicle is allowed to be used for VPP (step S220). The parking reservation management device 20 assigns a parking space other than the chargeable and dischargeable parking space 36 (the chargeable parking space 32 or the general parking space) to the vehicle for the parking reservation when it is determined that confirmation for either one of them has not been obtained. The parking reservation management device 20 then sends the control signal to display information such as the identification number and location of the assigned parking space in addition to the items entered in the parking reservation form on the users' terminal 220 (step S230).

The parking reservation management device 20 inputs the requested power adjustment period for the predetermined facility 60 from the power management system 40 (step S240) when it is determined that confirmation for both in steps S210 and S220 has been obtained. The requested power adjustment period for a predetermined facility 60 is a period of time determined by the power management system 40 as being necessary to charge and discharge the batteries installed in the vehicles parked in the chargeable and dischargeable parking space 36. This period is based on the power demand of the predetermined facility 60. This period is determined by taking into account the time of year and time of day when the power supplied by the other power supply source 50 cannot provide the power needed for the predetermined facility 60, and the time of year and time of day when the power supplied by the other power supply source 50 excessively exceeds the power needed for the predetermined facility 60. The parking reservation management device 20 then determines whether the deviation between the parking period based on the scheduled entry date and time and the scheduled exit date and time and the requested power adjustment period for the predetermined facility 60 is outside the predetermined range (step S240). That is, the parking reservation management device 20 determines whether or not the start of the parking period (scheduled entry date and time) is within the predetermined range of the start of the requested power adjustment period, and whether or not the end of the parking period (scheduled exit date and time) is within the predetermined range of the end of the requested power adjustment period. The predetermined range is, for example, 30 minutes or 1 hour. The predetermined range at the beginning of the parking period and the predetermined range at the end of the parking period may be different or the same range, respectively. The parking reservation management device 20 may determine whether or not to perform the confirmation process based on whether or not the predetermined ranges are matched.

When the parking reservation management device 20 determines that the deviation between the parking period and the requested power adjustment period for the predetermined facility 60 is within the predetermined range in step S250, the vehicle for the parking reservation is given a second benefit (second incentive) and allocated to the chargeable and dischargeable parking space 36. The parking reservation management device 20 then sends a control signal to display information on the users' terminal 220, such as the identification number and location of the chargeable and dischargeable parking space 36 allocated in addition to the items entered on the parking reservation form (step S280). The second benefit (second incentive) is a benefit that allows the battery to be charged at the scheduled exit date and time by a second predetermined amount of power more than at the time of entry, a benefit that provides a discount on the charging fee during parking, a benefit that allocates a chargeable and dischargeable parking space 36 with convenient access to the predetermined facility 60 among a plurality of chargeable and dischargeable parking space 36, a benefit that grants a gift certificate or other gift that can be used at the predetermined facility 60.

When the parking reservation management device 20 determines that the deviation between the parking period and the requested power adjustment period for the predetermined facility 60 is outside the predetermined range in step S250, the parking reservation management device 20 sends a control signal to the users' terminal 220 to display a request to change the parking period along with the scheduled entry date and time and the scheduled exit date and time for the parking reservation (step S260). The request to change the parking period can be, for example, “We would be willing to give you a privilege if you could move up your scheduled entry time by about an hour, could you please do so?” or “ We would be willing to give you a privilege if you could delay your scheduled exit time by about an hour, could you please do so?” can be used. In response to this request, the users' terminal 220 sends the input information with the changed scheduled entry date and time and scheduled exit date and time or an indication of intent not to change (step S120). In response to the transmission from the users' terminal 220, the parking reservation management device 20 determines whether the input from the users' terminal 220 is a change in the scheduled entry date and time or scheduled exit date and time such that the deviation between the parking period and the requested power adjustment period is within the predetermined range or whether the change is not possible (step S270). The parking reservation management device 20 gives the user a first benefit (first incentive) and assigns the user's vehicle to the chargeable and dischargeable parking space 36, when the parking reservation management device 20 determines that the input from the users' terminal 220 is a change in the scheduled entry date and time or scheduled exit date and time such that the deviation between the parking period and the requested power adjustment period is within the predetermined range. The parking reservation management device 20 then sends a control signal to the users' terminal 220 to display information such as the identification number and location of the chargeable and dischargeable parking space 36 allocated in addition to the items entered on the parking reservation form (step S290). The first benefit (first incentive) is preferable to the second benefit (second incentive), which is more favorable to the user. The first benefit (first incentive) is, for example, a benefit that allows the battery charge at the scheduled exit date and time to be higher than at the time of entry by the first predetermined amount of power (more than the second predetermined amount of power), a benefit that assigns the chargeable and dischargeable parking space 36 with more convenient access to the predetermined facility 60 out of a plurality of the chargeable and dischargeable parking space 36, and a benefit that grants a gift certificate or the like that can be used at the predetermined facility 60.

On the other hand, when the parking reservation management device 20 determines that the parking period cannot be changed in step S270, the parking reservation management device 20 gives the user the second benefit (second incentive) and assigns the user's vehicle to the chargeable and dischargeable parking space 36, in the same way as when the parking reservation management device 20 determines that the deviation between the parking period and the requested power adjustment period of the predetermined facility 60 is within the predetermined range. The parking reservation management device 20 then sends a control signal to display information on the users' terminal 220, such as the identification number and location of the chargeable and dischargeable parking space 36 allocated in addition to the items entered on the parking reservation form (step S280).

The user sends confirmation to the display on the users' terminal 220 (step S130). Upon receiving the confirmation, the parking reservation management device 20 sends a control signal indicating that the parking reservation has been confirmed (step S300) and ends the parking reservation process as the parking reservation management device 20. On the other hand, the users' terminal 220 displays the fact that the parking reservation from the parking reservation management device 20 has been confirmed (step S140), and ends the parking reservation process as the users' terminal 220.

The parking reservation management device 20 in the embodiment described above transmits to the users' terminal 220 a guide on whether or not the scheduled entry date and time and scheduled exit date and time can be changed so that the deviation between the parking period and the requested power adjustment period is within the predetermined range, when the deviation between the parking period based on the scheduled entry date and time and the scheduled exit date and time entered by the user and the requested power adjustment period for the predetermined facility 60 is outside the predetermined range. This will facilitate the change so that the deviation between the parking period and the requested power adjustment period is within the predetermined range. The result of this promotion is more appropriate parking timing for vehicles parked in the chargeable and dischargeable parking space 36 in the parking lot 30. Furthermore, the parking reservation management device 20 gives a first benefit (first incentive) to the user who changes the scheduled entry date and time or scheduled exit date and time so that the deviation between the parking period and the requested power adjustment period is within the predetermined range, and assigns the user's vehicle to the chargeable and dischargeable parking space 36. This will further facilitate the change so that the deviation between the parking period and the requested power adjustment period is within the predetermined range.

The parking reservation management device 20 in the embodiment performs, when making a parking reservation, a confirmation process to confirm that the vehicle to be parked is a vehicle whose battery is chargeable and dischargeable by the charging and discharging device 38, and that charging and discharging of the battery by the charging and discharging device 38 is allowed during parking. The parking reservation management device 20 then gives either the first benefit (first incentive) or the second benefit (second incentive) to the user who was confirmed by the confirmation process, and assigns the user's vehicle to the chargeable and dischargeable parking space 36. This can promote cooperation with the VPP and more effective exchange of power with the predetermined facility 60.

In the parking reservation management device 20 of the embodiment, when it is determined in step S250 that the deviation between the parking period and the requested power adjustment period of the predetermined facility 60 is within the predetermined range, or when it is determined in step S270 that the parking period cannot be changed, the second benefit (second incentive) is given to the user and assign the user's vehicle to the chargeable and dischargeable parking space 36.

However, when the parking reservation management device 20 determines in step S250 that the deviation between the parking period and the requested power adjustment period of the predetermined facility 60 is within the predetermined range, the parking reservation management device 20 may give the user a third benefit (third incentive) that is different from the second benefit (second incentive) and the user's vehicle may be assigned to the chargeable and dischargeable parking space 36. In this case, the third benefit (third incentive) should be intermediate in effect between the first benefit (first incentive) and the second benefit (second incentive).

The parking reservation management device 20 of the embodiment inputs on the parking reservation form whether the vehicle is chargeable and dischargeable to the battery installed in the vehicle and whether the battery installed in the vehicle is allowed to be used as a VPP while parked, and the parking reservation management device 20 uses the confirmation process to confirm that the vehicle is chargeable and dischargeable for use in the VPP and to confirm permission for use in the VPP. However, The parking reservation management device 20 may not make whether the vehicle is chargeable and dischargeable to the battery installed in the vehicle and whether the battery installed in the vehicle is allowed to be used as a VPP during parking as input items in the parking reservation form, and the parking reservation management device 20 may use the confirmation process to confirm that the vehicle is chargeable and dischargeable for use to the VPP and to confirm permission for use to the VPP.

The parking reservation management device 20 of the embodiment obtains the parking period based on the scheduled entry date and time and scheduled exit date and time entered in the parking reservation form on the users' terminal 220. However, if the predetermined facility 60 is an airport, the parking reservation management device 20 maybe used to input flight information such as departure date and time for departing flights and arrival date and time for arriving flights on the parking reservation form, and the parking reservation management device 20 may determine the parking period based on flight information. In this case, for example, the parking period can be determined from three hours before the departure date and time of the departing flight to two hours after the arrival date and time of the arriving flight.

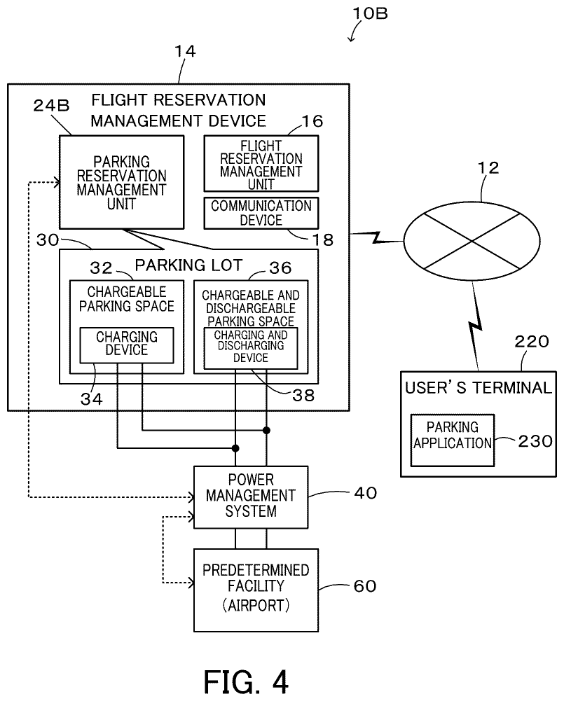

And if the predetermined facility 60 is an airport, the parking reservation management device 20 may make the parking reservation at the time of the flight reservation. In this case, as shown in the parking reservation system 10B illustrated in FIG. 4, the flight reservation management device 14 can include the flight reservation management unit 16 as a functional block for making flight reservations, the parking reservation management unit 24B as a functional block for making parking reservations, and the communication device 18. The flight reservation management device 14 first makes flight reservations using the flight reservation management unit 16, and then makes parking reservations using the parking reservation management unit 24B. When making this parking reservation, it is preferable that the scheduled entry date and time and scheduled exit date and time is automatically entered from the flight information. In this way, parking reservations are accepted at the time of flight reservations, reducing the hassle for users to make reservations, compared to accepting reservations individually.

The parking reservation management device 20 in the embodiment assumes an electric vehicle 120 that runs by using power from the battery 124 to drive the motor 122 as a vehicle that can use the chargeable and dischargeable parking space 36 in the parking lot 30. However, any vehicle that is equipped with a chargeable and dischargeable battery is acceptable. For example, the vehicle may be a hybrid vehicle with an engine, motor, and battery, or a fuel cell vehicle with a fuel cell and battery, or various other configurations.

The parking reservation system 10 in the embodiment comprises the communication network 12, the parking reservation management device 20, and the users' terminal 220. However, the users' terminal 220 may be an in-vehicle unit consisting of the electronic control unit 130 of the electric vehicle 120, the display unit 150, the communication unit 152, and so on. In this case, the parking reservation form may be pre-populated with information such as the user's name, the user's address, the scheduled date and time of entry into the parking lot, the scheduled date and time of exit from the parking lot, the type of the vehicle, and whether the vehicle is chargeable and dischargeable to the battery installed in the vehicle. A computer connected to the web may also be used as the users' terminal 220.

In the parking reservation system 10 of the embodiment, an airport is assumed as the predetermined facility 60. However, the predetermined facility 60 may also be a large leisure facility with a hotel or other facilities, a shopping center, a railroad station, a port, etc.

In the parking reservation management device of the present disclosure, the parking reservation management device may give a first incentive to the user when the user changes the direction in which the deviation between the desired facility-side power adjustment period and the vehicle-side power adjustment availability period is within the predetermined range. In this way, the user can be encouraged to change the vehicle side information in a direction where the deviation from the desired facility side power adjustment period is within the predetermined range. In this case, the parking reservation management device may give a second incentive to the user when the user does not change the direction in which the deviation between the desired facility-side power adjustment period and the vehicle-side power adjustment availability period is within the predetermined range. The second incentive can be the same as the first incentive, but it is preferable that it is less effective than the first incentive.

In the parking reservation management device of the present disclosure, the parking reservation management device may give a third incentive to the user when the deviation between the desired facility-side power adjustment period and the vehicle-side power adjustment availability period is within the predetermined range. The third incentive can be the same as the first or second incentive, but it is preferable that it is intermediate in effect between the first and second incentives.

In the parking reservation management device of the present disclosure, the user side information may include a scheduled entry date and time of the vehicle into the parking lot and a scheduled exit date and time of the vehicle from the parking lot, and the vehicle-side power adjustable period may be calculated based on the scheduled entry date and time and the scheduled exit date and time. In this way, the deviation between the desired facility-side power adjustment period and the vehicle-side power adjustment availability period can be calculated more appropriately.

In the parking reservation management device of the present disclosure, the parking lot may be attached to an airport, the user side information may include information of a flight used by the user, and the vehicle-side power adjustable period may be calculated based on the information of the flight. In this way, the vehicle-side power adjustable period can be calculated more appropriately.

In the parking reservation management device of the present disclosure, the parking lot may be attached to an airport, the parking reservation management device may be integrated into a flight reservation system at the airport, and the flight reservation system may be accepted parking reservations when accepting flight reservations. In this way, parking reservations can be accepted at the time of flight reservations, reducing the hassle for users to make reservations, compared to accepting reservations individually.

The following is an explanation of the correspondence between the main elements of the embodiment and the main elements of the invention described in the section on means to solve the problem. In the embodiment, the communication network 12 corresponds to “communication network”, the electric vehicle 120 corresponds to “ the vehicle”, the battery 124 corresponds to “the battery”, the charging device 34 corresponds to “the charging device”, the chargeable parking space 32 corresponds to “the chargeable parking space”, the charging and discharging device 38 corresponds to “the charging and discharging device”, the chargeable and dischargeable parking space 36 corresponds to “chargeable and dischargeable parking space,” the predetermined facility 60 corresponds to “ the predetermined facility,” the parking lot 30 corresponds to “ the parking lot,” and the parking reservation management device 20 corresponds to “ the parking reservation management device.”

The correspondence between the major elements of the embodiment and the major elements of the invention described in the means to solve a problem section is an example of how the embodiment can be used to specifically explain the embodiment of the invention described in the means to solve a problem section. This does not limit the elements of the invention described in the means to solve the problem section. In other words, interpretation of the invention described in the means to solve a problem section should be based on the description in that section, and the embodiment is only one specific example of the invention described in the means to solve a problem section.

The above is a description of the form for implementing this disclosure using the embodiment. However, the present disclosure is not limited in any way to these embodiments, and can of course be implemented in various forms within the scope that does not depart from the gist of the present disclosure.

### Industrial Applicability

This disclosure is applicable to the manufacturing industry for the parking reservation management device and other applications.

What is claimed is:

1. A parking reservation management device for a parking lot that can communicate via a communication network, having a chargeable and dischargeable parking space to which a charging and discharging device for charging and discharging a battery mounted on a vehicle is attached to at least a portion of all parking spaces, and capable of exchanging electric power between the parking lot and a predetermined facility, the parking reservation management device is characterized by:
sending a changing availability guide to a user to inform whether a user side information can be changed or not, when a deviation between a desired facility-side power adjustment period based on a power demand at the predetermined facility and a vehicle-side power adjustment availability period obtained based on the user side information on the use of the parking lot input by the user is outside a predetermined range.

2. The parking reservation management device according to claim 1, wherein
the parking reservation management device gives a first incentive to the user, when the user changes the direction in which the deviation between the desired facility-side power adjustment period and the vehicle-side power adjustment availability period is within the predetermined range.

3. The parking reservation management device according to claim 2, wherein
the parking reservation management device gives a second incentive to the user, when the user has not changed the direction in which the deviation between the desired facility-side power adjustment period and the vehicle-side power adjustment availability period is within the predetermined range.

4. The parking reservation management device according to claim 1, wherein
the parking reservation management device gives a third incentive to the user, when the deviation between the desired facility-side power adjustment period and the vehicle-side power adjustment availability period is within the predetermined range.

5. The parking reservation management device according to claim 1, wherein
the user side information includes a scheduled entry date and time of the vehicle into the parking lot and a scheduled exit date and time of the vehicle from the parking lot,
the vehicle-side power adjustable period is calculated based on the scheduled entry date and time and the scheduled exit date and time.

6. The parking reservation management device according to claim 1, wherein
the parking lot is attached to an airport,
the user side information includes information of a flight used by the user,
the vehicle-side power adjustable period is calculated based on the information of the flight.

7. The parking reservation management device according to claim 1, wherein
the parking lot is attached to an airport,
the parking reservation management device is integrated into a flight reservation system at the airport,
the flight reservation system accepts parking reservations when accepting flight reservations.
